(19) United States
(12) Patent Application Publication
(10) Pub. No.: US 2005/0286067 A1
(43) Pub. Date: Dec. 29, 2005

(54) Estimating a composition time

(76) Inventors: Douglas J. Mellor, Meridian, ID (US); Daniel L. George, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/875,043

(22) Filed: Jun. 23, 2004

(51) Int. Cl. G06F 15/00

(52) U.S. Cl. 358/1.14

(57) ABSTRACT

An estimation method includes identifying a timing factor for a print job. The timing factor is then used to estimate a composition time for the print job.

### BACKGROUND

To prepare an electro-photographic imaging device—such as a laser printer—for producing a printed image, the device may be warmed-up. An exemplary warm-up process includes spinning up a mirror that guides the laser, pulling print media from a tray, and heating the fuser. To increase the life span of such an imaging device, the device is placed in an idle state when not in use. This means that after a set amount of time of non-use, the mirror is spun down and the fuser is allowed to cool.

Such a warm-up process takes time. Consequently it can take longer to print the first page of a document than to print the subsequent pages. Users appreciate steps taken to avoid delays and can become irritated when forced to wait for a document to print. Providing an imaging device that can reduce printing delays improves the overall consumer experience and affords the imaging device a key selling point.

### DESCRIPTION OF THE DRAWINGS

FIG. 1 is a schematic representation of an exemplary computing environment in which embodiments of the present invention may be incorporated.

FIG. 2 illustrates a printed document that includes graphics and text.

FIG. 3 is a block diagram illustrating exemplary components of an image forming device according to an embodiment of the present invention.

FIG. 4 is a block diagram illustrating exemplary components of an estimation module according to an embodiment of the present invention.

FIGS. 5-8 are exemplary flow diagrams illustrating steps taken to warm-up an image forming device according to embodiments of the present invention.

FIGS. 9-12 help provide examples that illustrate how embodiments of the present invention can decrease warm-up delays.

### DETAILED DESCRIPTION OF THE INVENTION

INTRODUCTION: Image forming devices can include components that benefit from warming-up prior to use. Steps taken to warm-up a laser printer, for example, can include spinning up the mirror that guides the laser, pulling paper from a selected paper tray, and heating the fuser. To increase the life span of such an imaging device, the device is placed in an idle state when not in use.

The warm-up process generally takes the same amount of time each time it is performed. In some cases, that is typically dictated by the time required to heat the fuser to a suitable temperature. The process of converting electronic printing instructions to a form that can be printed also takes time. Embodiments of the present invention operate to estimate the time it will take to complete the conversion process. Using an estimated conversion time, embodiments of the present invention attempt to schedule the warm-up process so that its completion closely coincides with the scheduled completion of the conversion process.

If the conversion process requires less time than estimated, the warm-up process will start late causing a printing delay. If the conversion process takes longer than expected, the warm-up process will start too soon, potentially decreasing the life span of the image forming device. Eventually, while waiting for the conversion process to complete, the warmed-up image forming device may place itself back in an idle state. The warm-up process is then instigated again once the conversion process is completed resulting in a printing delay.

The following description is broken into sections. The first section describes an environment in which embodiments of the present invention may be implemented. The second section describes the physical and logical components of an image forming device that are used to implement embodiments of the present invention. The third section describes steps taken to practice embodiments of the present invention. And the fourth section provides examples of how embodiments of the present invention can help decrease warm-up delays.

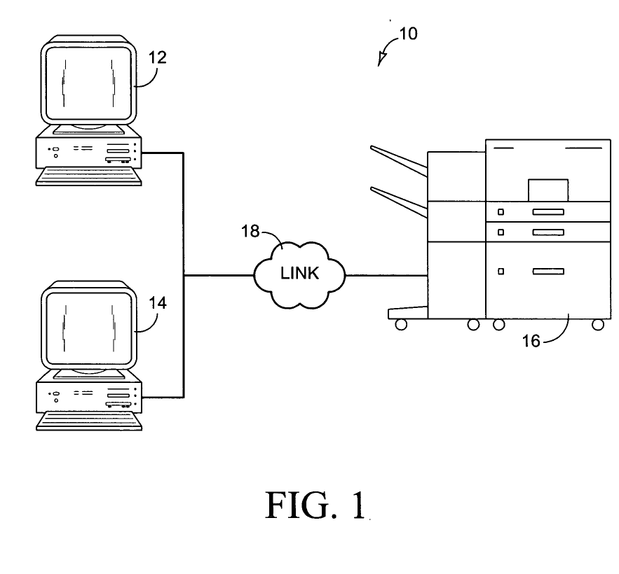

ENVIRONMENT: FIG. 1 illustrates a printing environment 10 in which it would be advantageous to implement embodiments of the present invention. Environment 10 includes computers 12 and 14 and image forming device 16. Computers 12 and 14 represent generally any computing device such as a desktop computer, laptop computer, or PDA (Personal Digital Assistant) that may send a print job to image forming device 16. Image forming device 16 represents generally any combination of hardware and programming capable of processing a print job and producing an image such as text and graphics on a media sheet such as paper or transparency. Examples include printers, copiers, and facsimile machines as well as multi-function devices that provide all three functions. It is noted that where an image forming device functions as a copier, it can create a print job without the need for computers 12 and 14.

Computers 12 and 14 and image forming device 16 are interconnected by link 18. Link 18 represents generally a cable, wireless, or remote connection via a telecommunication link, an infrared link, a radio frequency link, and/or any other connector or system that provides electronic communication between devices 12-16. Link 18 may represent an intranet, the Internet, or a combination of both.

The term print job refers to a series of instructions directing image forming device 16 to produce images on one or more media sheets. The instructions may include directions to form text, graphics, or a combination of both. A print job may be generated by computer 12 or 14 or directly from image forming device 16 where the image forming device functions as a copier. The instructions may also include finishing directions such as directions to print multiple, collated copies.

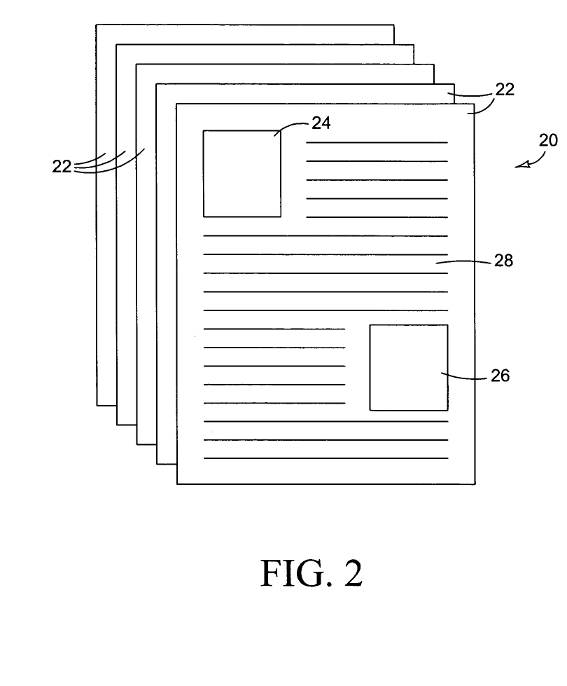

A print job can be in PDL (Page Description Language) format. The PDL format describes the layout and contents of a printed page or pages. Modern versions of the PDL format are object-oriented, meaning that they describe a page in terms of geometrical objects such as text, bitmap images, and vector images. FIG. 2 illustrates an exemplary printed document 20 having multiple pages 22. The top page 22 is shown to include graphics 24 and 26 and text 28. The print job guiding the production of document 20 includes objects that define graphics 24 and 26 and specify text 28. The instructions also guide the placement of text 28 and graphics 24 and 26.

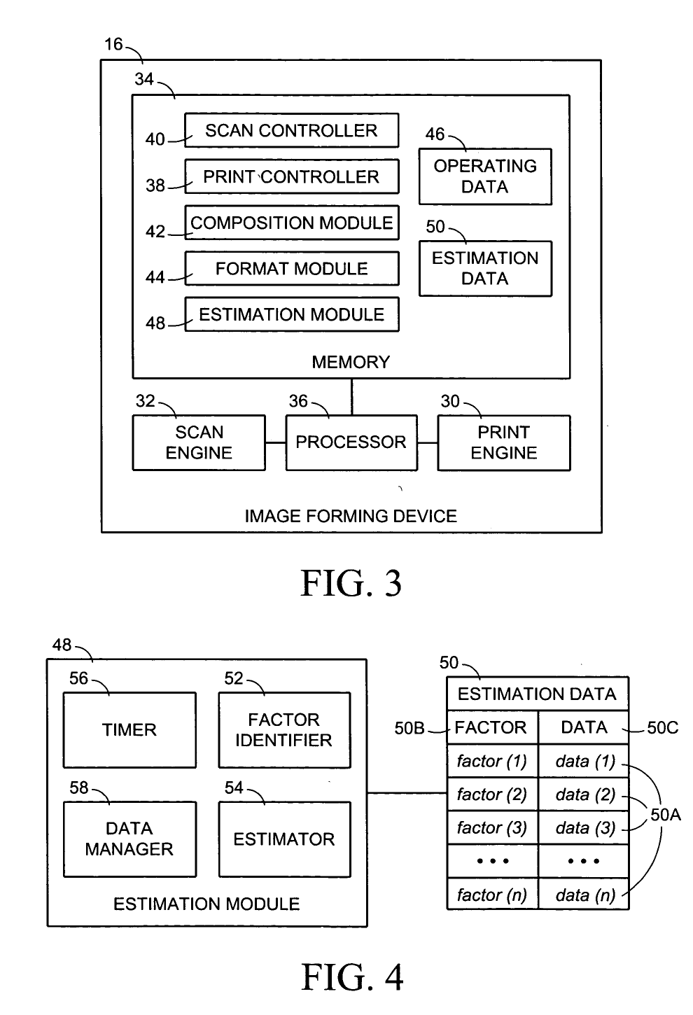

COMPONENTS: The logical components of one embodiment of the invention will now be described with reference to the block diagrams of FIGS. 3 and 4. Beginning with FIG. 3, image forming-device 16 includes, among other components not shown, print engine 30, scan engine 32, memory 34, and processor 36.

Print engine 30 represents generally the hardware capable of forming an image on a medium such as paper. Where, for example, image forming device 16 is a laser printer, print engine 30 includes an optical scanner, a photo conducting drum, toner and a fuser. The optical scanner modulates a laser beam across the drum. The scanned portions of the drum attract toner. Toner is transferred from the drum to a media sheet forming the desired image. The fuser makes the toner transfer permanent.

Scan engine 32 represents generally any hardware capable of being used to generate a digital representation of a physical image. Scan engine 32 may, for example, include a charge-coupled device (CCD) array, which consists of tightly packed rows of light receptors that can detect variations in light intensity and frequency. An image can be digitized by passing it over the CCD array. Print engine 30 can then be employed to use the digitized image to form a copy of the physical image on a medium such as paper.

Memory 34 represents any computer readable medium that can store program instructions and other data used to guide the operation of print engine 30 and scan engine 32. Processor 36 represents any processor capable of executing program instructions from programming stored in memory 34.

As illustrated, memory 34 includes print controller 38, scan controller 40, composition module 42, format module 44, operating data 46, estimation module 48, and estimation data 50. Print controller 38 represents generally any program instructions that when executed cause print engine 30 to form an image on a medium such as a sheet of paper—the image formed being defined by a formatted print job. Print controller 38 is also responsible for scheduling and initiating a warm-up process for print engine 30. Scan controller 40 represents generally any program instructions that when executed cause scan engine 32 to scan an image generating a digital copy of a physical image.

Composition module 42 represents generally any program instructions that when executed compose a print job from the printing instructions into a print job. This can include reading printing instructions, streamed over an interface from a computer, and assembling a print job. It can also include assembling a print job from a scanned image obtained from scan controller 40.

Format module 44 represents generally any program instructions that when executed convert a print job into a format that can be utilized by print controller 38 in guiding print engine 30 to form a desired image. For example, format module 44 includes program instructions for rendering a print job into a binary stream of print job data that defines the location and properties of each pixel to be printed by print engine 30. A binary data stream that defines the location and properties of each pixel is relatively quite large, so format module 44 may also include instructions for compressing the data stream into a more manageable size and for storing compressed data stream as operating data 46. Print controller 38 can then fetch operating data 46 to guide print engine 30 in the production of a desired image.

Estimation module 48 represents program instructions that when executed estimate the times required for composition module 42 and format module 44 to complete the processes of assembling and formatting. Format times may for example be estimated instead by print controller 38. Estimation data 50 represents data used by estimation module 48 to estimate composition and format times. Examples of estimation module 48 and estimation data 50 are described below with reference to FIG. 4. Estimation module 48 is responsible for providing estimation data 50 to print controller 38 so that print controller 38 can schedule the warm-up process for print engine 30 accordingly.

Using the composition and format time estimates provided by estimation module 48, print controller 38 can schedule the warm-up process for print engine 30 so that its completion closely coincides with at least a partial completion of the format process. The format process can be said to be at least partially complete when a portion of a print job has been formatted and can be utilized by print controller 38. In this manner, the warm-up process can be timed so that print engine 30 is warmed up just in time to allow print controller 38 to process the formatted print job or portion thereof and guide print engine 30 to produce a desired image.

Moving to FIG. 4, estimation module 48 is shown to include factor identifier 52, estimator 54, timer 56, and data manager 58. Factor identifier 52 represents program instructions that when executed identify timing factors for a print job. Timing factors include any factors that can affect or in some manner relate to the time required to compose or format a print job. An example of a timing factor is the type of interface over which printing instructions are streamed from computer 12 or 14 to image forming device 16 (FIG. 1). Possible interfaces include parallel port, Ethernet, USB (Universal Serial Bus), and wireless, using protocols such as Bluetooth. Empirical data has shown that composition times are less when certain interfaces are used.

Other timing factors include selection of certain composition options such as “N into one” page composition, page rotation, border erase, the addition of a watermark, and the like. The more computational time required by a composition option, the longer the composition process will take. Timing factors also include characteristics of the print job such as whether the print job is vector dominated, bitmap dominated, or text dominated. Bitmap dominated print jobs can take longer to compose than text or vector dominated print jobs.

Estimator 54 represents program instructions that when executed use an identified timing factor to estimate a time required to compose a print job. In doing so, estimator 54 may access estimation data 50. In the example shown, estimation data 50 is a table containing a series of entries 50A. Each entry 50A contains a factor field 50B and a data field 50C. Factor field 50B for a given entry 50A contains data corresponding to one or more identifiable timing factors. Data field 50C contains timing data corresponding to those timing factors. Factor identifier 52 identifies timing factors for a given print job. Estimator 54 then accesses an entry 50A containing data in factor field 50B that corresponds to those timing factors. From that entry 50A, estimator 54 obtains timing data from data field 50C. Using the timing data, estimator 54 estimates the time required to compose the print job.

Timing data is any data that can be used to estimate a composition time. Timing data, for example, can include an average composition time and a maximum composition time. The average composition time can be used to estimate a time it will likely take to compose a print job based on one or more timing factors. The maximum composition time can be used to estimate a maximum time it might take to compose the print job. The average composition time for example can be an average of the times it has historically taken to compose print jobs based on a particular timing factor or timing factors. The maximum composition time can be the maximum time it has historically taken to compose a print job based on a particular timing factor or timing factors.

Estimator 54 can then estimate a composition time by providing print controller 38 (FIG. 3) an average composition time and a maximum composition time corresponding to an identified timing factor. Print controller 38 can then determine whether to use the maximum composition time or the average composition time as the composition time estimate. Print controller 38 can make that determination, for example, based on the following: If there is a risk that print engine 30 (FIG. 3) will be warmed up too soon and place itself in an idle state if the average composition time is selected—and—the actual composition time is closer to the maximum composition time, then print controller 38 may select the maximum composition time as the composition time estimate. Otherwise, print controller 38 may select the average composition time as the composition time estimate.

Timer 56 represents program instructions that when executed monitor the actual times required to compose each print job. Data manager 58 represents program instructions that when executed update estimation data 50 based on actual composition times recorded by timer 56 and timing factors identified by factor identifier 52. In this example, factor identifier 52 identifies timing factors for a given print job. Data manager 58 then accesses an entry 50A containing data in factor field 50B that corresponds to those timing factors. For that entry 50A, data manager 58 updates timing data in data field 50C using the actual time required to compose the print job identified by timer 56.

Composition times for a given image forming device can vary based on the printing habits of a user or users and the particular environment in which the image forming device operates. Data manager 58 periodically updates estimation data 50 based on actual composition times so that estimation data 50 remains generally reflective of the printing habits of a user or group of users and of the environment in which the image forming device operates. In this manner estimating composition times is made more efficient because the estimations rely on tracked trends of past print jobs. A composition time estimate can be made by simply accessing a table entry 50A corresponding to an identified timing factor. Data in the table entry 50A in some manner indicates an average time it has historically taken to compose a print job with the identified timing factor

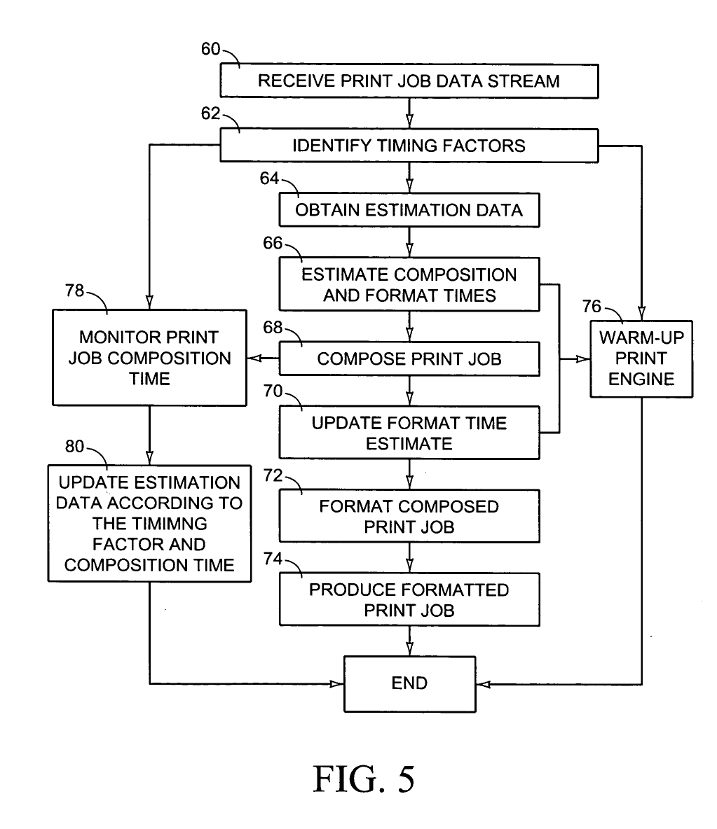

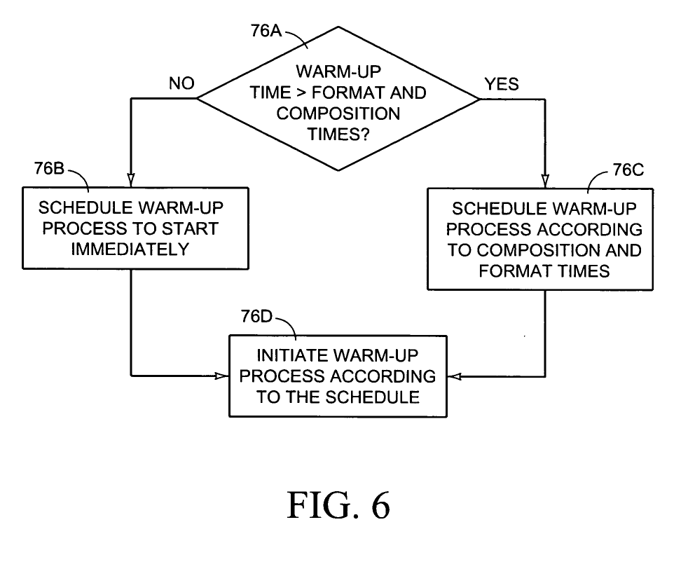

OPERATION: The operation of exemplary embodiments will now be described with reference to FIGS. 5 and 6. FIG. 5 is a flow diagram illustrating steps taken to warm-up an image forming device in preparation for producing a print job composed from printing instructions received from a computer. FIG. 6 is a flow diagram illustrating steps taken to warm-up an image forming device in preparation for producing a scanned print job—that is—a print job generated by scanning a document.

Starting with FIG. 5, an image forming device receives printing instructions (step 60). Timing factors are identified (step 62). At this point the process separates into three threads. The first thread is represented as steps 64-74, the second thread is represented by step 76, and the third thread is represented by steps 78-80.

Referring to the first thread, estimation data corresponding to the identified timing factors is obtained (step 64). Composition and format times are estimated (step 66). The print job is composed (step 68). The estimated format time is updated (step 70), the print job is formatted (step 72), and the formatted print job is produced (step 74).

It is noted that estimating composition and format times in step 66 and then updating the format time estimate 70 improves overall reliability. The estimates made in step 66 are relatively coarse being based on historical averages for assembling and formatting print jobs based on identified timing factors. The updated format time estimate made in step 70 is relatively precise.

Moving to the second thread, the print engine is warmed up according to the composition and format times estimated in steps 66 and 70 (step 76). FIG. 6 is an exemplary flow diagram expanding on step 76. It is initially determined whether the time it takes to complete the warm-up process exceeds the estimated format and composition times (step 76A). If not the warm-up process is scheduled to start immediately (step 76B). If the estimated composition and format times exceed the time required to complete the warm-up process, the warm-up process is scheduled to according to the estimated composition and format times (step 76C). In other words, the warm-up process is scheduled to start so that its completion will closely coincide with the completion of formatting in step 72 (FIG. 5). The warm-up process is then initiated according to the schedule determined in step 76B or 76C (step 76D).

Referring back to FIG. 5 and moving to the third thread, an actual composition time for the print job composed in step 68 is monitored (step 78). The estimation data corresponding to the timing factors identified in step 62 is then updated based on the actual composition time (step 80). In this manner composition times estimated in step 66 can be personalized to the image forming device and the environment in which the device operates.

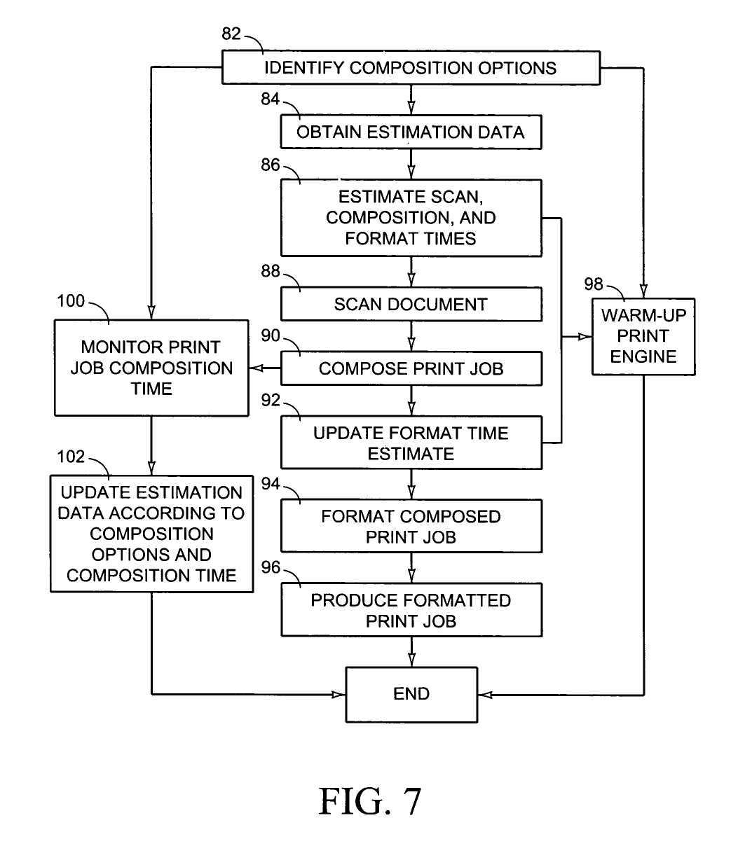

Referring now to FIG. 7, an image forming device is prepared to scan a document. Composition options are identified (step 82). Composition options are timing factors related to the composition of a print job for the scanned document. Composition options, for example can include the addition of a watermark, an “N into one” page composition, border erase, and the like. At this point the process separates into three threads. The first thread is represented as steps 84-96, the second thread is represented by step 98, and the third thread is represented by steps 100-102.

Referring to the first thread, estimation data corresponding to the identified composition options is obtained (step 84). Scan, composition, and format times are estimated (step 86). The document is scanned (step 88). A corresponding print job is composed (step 90). The estimated format time is updated (step 92), the print job is formatted (step 94), and the formatted print job is produced (step 96).

It is noted that estimating composition and format times in step 86 and then updating the format time estimate 92, improves overall reliability. The composition and format time estimates made in step 86 are relatively coarse being based on historical averages for assembling and formatting print jobs based on identified timing factors. The updated format time estimate made in step 92 is relatively precise.

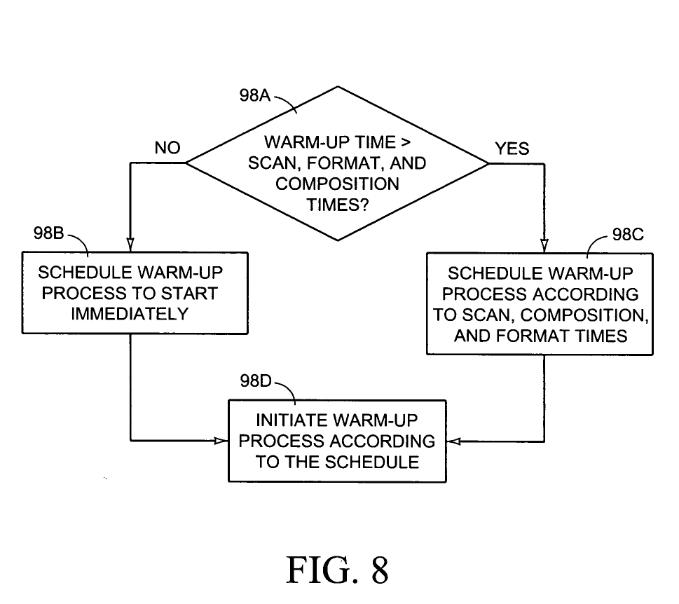

Moving to the second thread, the print engine is warmed up according to the scan, composition, and format times estimated in steps 86 and 92 (step 98). FIG. 8 is an exemplary flow diagram expanding on step 98. It is initially determined whether the time it takes to complete the warm-up process exceeds the estimated scan, composition, and format times (step 98A). If not the warm-up process is scheduled to start immediately (step 98B). If the estimated composition and format times exceed the time required to complete the warm-up process, the warm-up process is scheduled to according to the estimated composition and format times (step 98C). In other words, the warm-up process is scheduled to start so that its completion will closely coincide with the completion of formatting in step 94 (FIG. 7) The warm-up process is then initiated according to the schedule determined in step 98B or 98C (step 98D).

Referring back to FIG. 7 and moving to the third thread, an actual composition time for the print job composed in step 90 is monitored (step 100). The estimation data corresponding to the composition options identified in step 82 is then updated based on the actual composition time (step 102)). In this manner, composition times estimated in step 86 can be personalized to the image forming device and the environment in which the device operates.

### EXAMPLES

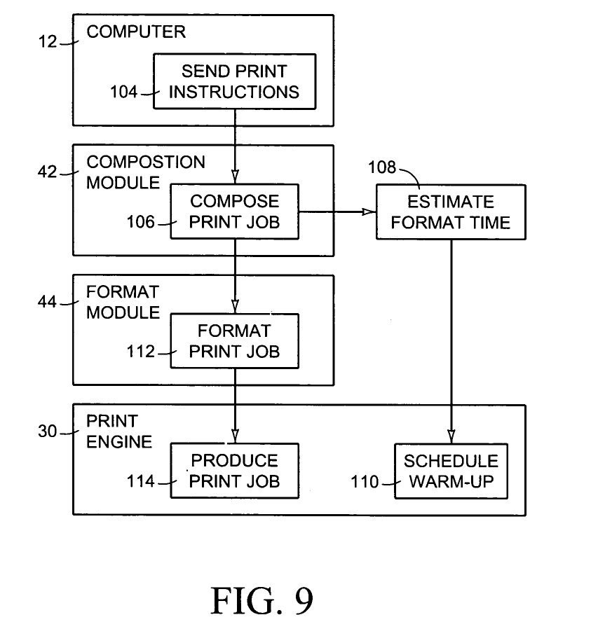

FIGS. 9-12 help to illustrate how embodiments of the present invention can operate to reduce warm-up delays for an image forming device. FIG. 9 illustrates a printing process in which the time required to compose a print job is not estimated. Computer 12 sends printing instructions (step 104). Composition module 42 composes the print job from the printing instructions (step 106). A format time for the print job is estimated (step 108). Print engine 30 schedules a warm-up process according to the format time estimate (step 110). Format module 44 formats the print job (step 112), and print engine 30 produces the print job (step 114).

As an example, assume that it takes four seconds to warm-up print engine 30, and for a particular print job it takes eight seconds to compose in step 106 and two seconds to format in step 112. Once the print job is composed in step 106, print engine 30 knows that it will take only two seconds to format the print job, so it starts the warm-up process right away. The format process completes, and it takes another two seconds before print engine 30 is ready to produce the print job in step 114. The user endures a combined twelve second delay—approximately two seconds of which is attributable exclusively to the warm-up process.

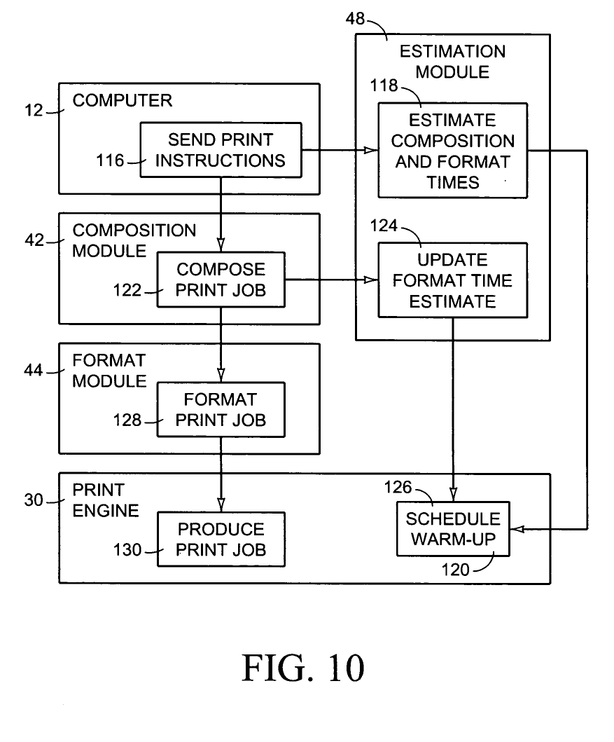

FIG. 10 illustrates a printing process in which the time required to compose a print job is estimated. Computer 12 sends printing instructions (step 116). Estimation module 48 estimates composition and format times (step 118). Print engine 30 schedules a warm-up process according to the composition and format time estimates (step 120). Composition module 42 composes the print job (step 122). The format time estimate for the print job is updated (step 124). Print engine 30 updates the schedule for the warm-up process according to the format time update (step 126). Format module 44 formats the print job (step 128), and print engine 30 produces the print job (step 130).

Using the example above, assume that it takes four seconds to warm-up print engine 30, and for the particular print job it takes eight seconds to compose in step 122 and two seconds to format in step 128. Print engine 30 can then assume that it will take ten seconds to compose and format the print job, so, in step 120, print engine 30 can set the warm-up to start approximately six seconds after the start of the composition process. Based on the estimates, the completion of formatting in step 128 will closely coincide with the completion of the warm-up process. The user endures a combined delay of ten seconds—none or relatively little of which is attributable exclusively to the warm-up process.

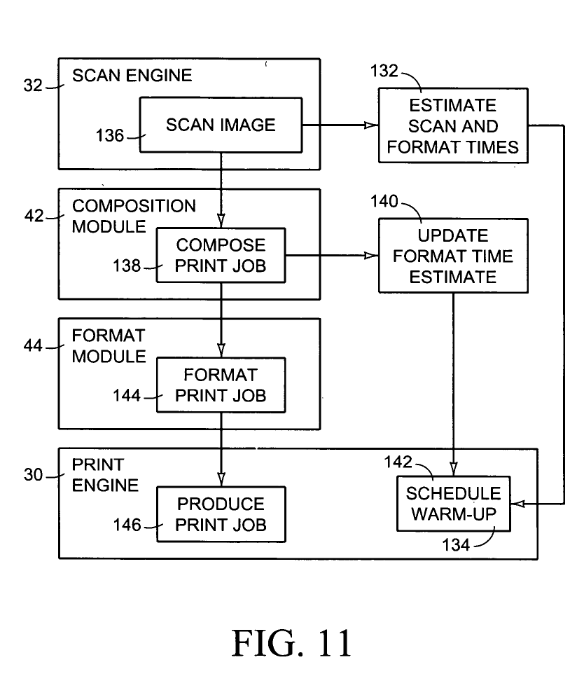

FIG. 11 illustrates a printing process in which the time required to compose a scanned print job is not estimated. Scan and format times are estimated (step 132). Print engine 30 schedules a warm-up process according to the scan and format time estimates (step 134). Scan engine 32 scans an image (step 136). Composition module 42 composes a print job from the scanned image (step 138). The format time estimate is updated (step 140), and print engine 30 updates the warm-up process schedule accordingly (step 142). Format module 44 formats the print job (step 144), and print engine 30 produces the print job (step 146).

As an example, assume that it takes four seconds to warm-up print engine 30, scanning takes two seconds, and for a particular print job it takes fifteen seconds to compose in step 138 and two seconds to format in step 144. Not informed of a composition time, print engine 30 assumes that the print job will be ready in four seconds (two seconds to scan plus two seconds to format), so it starts the warm-up process right away in step 134. Print engine 30 completes the warm-up process approximately two seconds into the composition process. Completion of the composition process and the format process take another fifteen seconds.

Assume also that print engine 30, to avoid wear and tear and to prolong its life, is placed in an idle state after ten seconds of non-use and that this process takes five seconds. In this case, as the composition process nears completion, print engine 30 is placed in an idle state. Meanwhile, the composed print job is formatted in step 144 with as the idling process completes. Once in an idle state, print engine 30 warms up again taking another four seconds beyond the time required to format the print print job. The user endures a combined twenty-three second delay—approximately four seconds of which is attributable exclusively to the warm-up process.

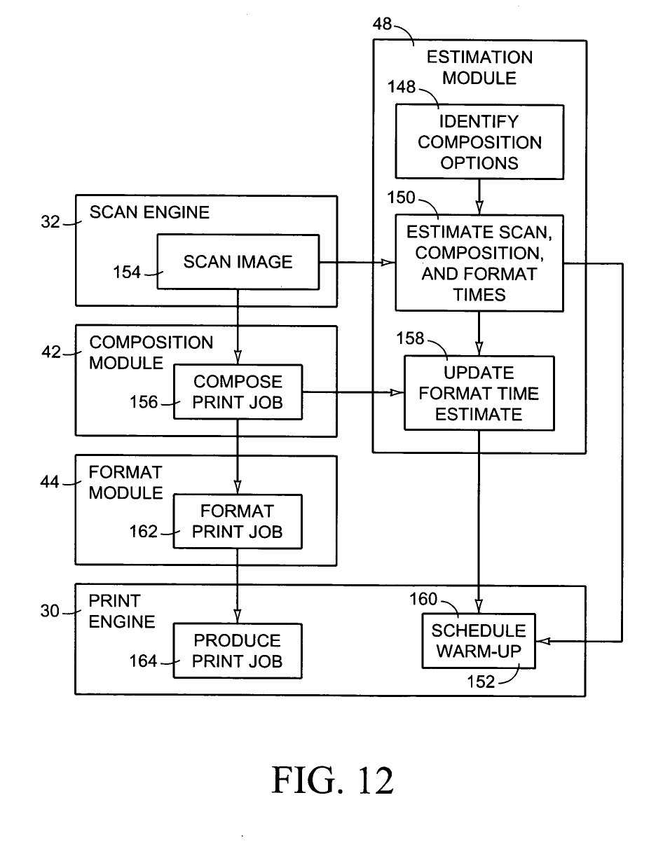

FIG. 12 illustrates a printing process in which the time required to compose a scanned print job is estimated. Estimation module 48 identifies composition options (step 148) and estimates scan, composition, and format times (step 150). Print engine 30 schedules a warm-up process according to the scan, composition, and format time estimates (step 152). Scan engine 32 scans an image (step 154). Composition module 42 composes a print job from the scanned image according to the composition options (step 156). The format time estimate is updated (step 158), and print engine 30 updates warm-up process schedule accordingly (step 160). Format module 44 formats the print job (step 162), and print engine 30 produces the print job (step 164).

Continuing with the example above, assume that it takes four seconds to warm-up print engine 30, scanning takes two seconds, and it takes fiftenn seconds to compose the particular print job in step 156 and two seconds to format in step 162. Also assume that print engine 30 places itself in an idle state after ten seconds of non-use. Informed of scan, composition, and format times, print engine 30 determines that it should start the warm-up process four seconds before the format process is to complete. In this example, the warm-up process is scheduled to start thirteen seconds after the start of the composition process.

Assuming the time estimates to be accurate, the completion of the warm-up process closely coincides with the completion of the format process preventing print engine 30 from being placed in an idle state. The user endures a combined nineteen second delay—none or relatively little of which is attributable exclusively to the warm-up process.

### CONCLUSION

The block diagrams of FIGS. 3 and 4 show the architecture and functionality of an exemplary embodiment of the present invention. Each block in FIGS. 3 and 4 may represent in whole or in part a module, segment, or portion of code that comprises one or more executable instructions to implement the specified logical function(s). Each block may represent a circuit or a number of interconnected circuits to implement the specified logical function(s).

Also, the present invention can be embodied in any computer-readable medium for use by or in connection with an instruction execution system such as a computer/processor based system or an ASIC (Application Specific Integrated Circuit) or other system that can fetch or obtain the logic from computer-readable media and execute the instructions contained therein. “Computer-readable medium” can be any of one or more computer readable media that can contain, store, or maintain programs and data for use by or in connection with the instruction execution system. A computer readable medium can comprise any one or more of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow charts of FIGS. 5-8 show specific orders of execution, the orders of execution may differ from those depicted. For example, the order of execution of two or more blocks may be scrambled relative to the order shown. Also, two or more blocks shown in succession may be executed concurrently or with partial concurrence. All such variations are within the scope of the present invention.

Embodiments of the present invention have been shown and described with reference to the foregoing exemplary implementations. It is to be understood, however, that other forms, details, and embodiments may be made without departing from the spirit and scope of the invention which is defined in the following claims.

1. An estimation method, comprising:
identifying a timing factor for a print job; and
estimating a composition time for the print job based on the timing factor.

2. The method of claim 1, further comprising scheduling a warm-up process for a print engine according to the estimated composition time.

3. The method of claim 2, wherein scheduling comprises scheduling the warm-up process for the print engine according to the composition time and an estimated format time.

4. The method of claim 3, further comprising:
updating the estimated format time after the print job is composed; and
updating the warm-up process schedule according to the updated format time estimate.

5. The method of claim 3, wherein scheduling comprises scheduling the warm-up process so that a completion of the warm-up process is scheduled to closely coincide with at least a partial completion of the formatting of the print job based on the estimated composition and format times.

6. The method of claim 1, wherein identifying a timing factor comprises identifying a composition option for an image to be scanned, and wherein estimating comprises estimating a composition time for the print job according to the composition option, the method further comprising scheduling a warm-up process for a print engine according to the composition time, an estimated format time, and an estimated scan time.

7. The method of claim 6, further comprising:
updating the estimated format time after the image is scanned and the print job is composed; and
updating the warm-up process schedule according to the updated format time estimate.

8. The method of claim 1, wherein estimating comprises acquiring timing data corresponding to the timing factor and estimating the composition time based on the timing data.

9. The method of claim 8, wherein the timing data includes a maximum composition time and an average composition time and wherein estimating the composition time based on the composition data comprises providing the maximum composition time and the average composition time.

10. A method, comprising:
identifying a first timing factor for a first print job;
monitoring an actual time required to compose the first print job; and
associating the actual time with the first timing factor.

11. The method of claim 10, wherein associating comprises updating first timing data corresponding to the first timing factor to reflect the actual time required to compose the first print job.

12. The method of claim 11, further comprising:
identifying a second timing factor for a second print job; and
obtaining second timing data corresponding to the second timing factor to estimate a composition time for the second print job.

13. The method of claim 12, wherein the second timing factor is the same as the first timing factor so that the estimated composition time for the second print job is based at least in part on the actual time required to compose the first print job.

14. A method for producing a print job; comprising:
identifying a timing factor for a print job;
estimating a composition time and a format time for the print job, the composition time being based at least in part on the timing factor;
assembling the print job;
formatting the print job;
initiating a warm-up process for a print engine according to the estimated composition time and format time so the warm-up process is scheduled to complete as at least a portion of the print job is formatted and in condition to be printed; and
directing the print engine to begin producing the formatted print job once the warm-up process is complete.

15. The method of claim 14, further comprising updating the estimated format time, and wherein initiating comprises initiating the warm-up process for the print engine according to the updated format time.

16. The method of claim 14, further comprising receiving printing instructions ad wherein assembling comprises assembling the print job from the printing instructions.

17. The method of claim 14, wherein identifying a timing factor comprises identifying a composition option for an image to be scanned, the method further comprising directing a scan engine to scan the image, and wherein assembling comprises assembling the print job from the scanned image according to the composition option.

18. The method of claim 14, further comprising monitoring an actual time required to compose the print job and associating the actual time with the timing factor.

19. The method of claim 18, wherein associating comprises updating timing data corresponding to the timing factor to reflect the actual time required to compose the print job.

20. A computer readable medium having instructions for:
identifying a timing factor for a print job; and
estimating a composition time for the print job based on the timing factor.

21. The medium of claim 20, having further instructions for setting a start time for a warm-up process for a print engine according to the estimated composition time.

22. The medium of claim 21, wherein the instructions for scheduling include instructions for scheduling the warm-up process for the print engine according to the composition time and an estimated format time.

23. The medium of claim 22, having further instructions for:
updating the estimated format time after the print job is composed; and
updating the warm-up process schedule according to the updated format time estimate.

24. The medium of claim 22, wherein the instructions for scheduling include instructions for scheduling the warm-up process so that a completion of the warm-up process is scheduled to closely coincide with at least a partial completion of the formatting of the print job based on the estimated composition and format times.

25. The medium of claim 20, wherein the instructions for identifying a timing factor include instructions for identifying a composition option for an image to be scanned, and wherein the instructions for estimating include instructions for estimating a composition time for the print job according to the composition option, the medium having further instructions for scheduling a warm-up process for a print engine according to the composition time, an estimated format time, and an estimated scan time.

26. The medium of claim 25, having further instructions for:
updating the estimated format time after the image is scanned and the print job is composed; and
updating the warm-up process schedule according to the updated format time estimate.

27. The medium of claim 20, wherein the instructions for estimating include instructions for acquiring timing data corresponding to the timing factor and estimating the composition time based on the timing data.

28. The medium of claim 27, wherein the timing data include a maximum composition time and an average composition time and wherein the instructions for estimating the composition time based on the composition data include instructions for providing the maximum composition time and the average composition time.

29. A medium, comprising:
identifying a first timing factor for a first print job;
monitoring an actual time required to compose the first print job; and
associating the actual time with the first timing factor.

30. The medium of claim 29, wherein the instructions for associating include instructions for updating first timing data corresponding to the first timing factor to reflect the actual time required to compose the first print job.

31. The medium of claim 30, having further instructions for:
identifying a second timing factor for a second print job; and
obtaining second timing data corresponding to the second timing factor to estimate a composition time for the second print job.

32. The medium of claim 31, wherein the second timing factor is the same as the first timing factor so that the estimated composition time for the second print job is based at least in part on the actual time required to compose the first print job.

33. A medium for producing a print job; comprising:
identifying a timing factor for a print job;
estimating a composition time and a format time for the print job, the composition time being based at least in part on the timing factor;
assembling the print job;
formatting the print job;
initiating a warm-up process for a print engine according to the estimated composition time and format time so the warm-up process is scheduled to complete as at least a portion of the print job is formatted and in condition to be printed; and
directing the print engine to begin producing the formatted print job once the warm-up process is complete.

34. The medium of claim 33, having further instructions for updating the estimated format time, and wherein the instructions for initiating include instructions for initiating the warm-up process for the print engine according to the updated format time.

35. The medium of claim 33, having further instructions for receiving printing instructions and wherein the instructions for assembling include instructions for assembling the print job from the printing instructions.

36. The medium of claim 33, wherein the instructions for identifying a timing factor include instructions for identifying a composition option for an image to be scanned, the medium having further instructions for directing a scan engine to scan the image, and wherein the instructions for assembling include instructions for assembling the print job from the scanned image according to the composition option.

37. The medium of claim 33, having further instructions for monitoring an actual time required to compose the print job and associating the actual time with the timing factor.

38. The medium of claim 37, wherein the instructions for associating include instructions for updating timing data corresponding to the timing factor to reflect the actual time required to compose the print job.

39. An estimation system, comprising:
a computer readable medium storing program instructions for identifying a timing factor for a print job and for estimating a composition time for the print job based on the timing factor; and
a processor operable to execute the program instructions.

40. The system of claim 39, wherein the computer readable medium stores program instructions for scheduling a warm-up process for a print engine according to an estimated composition time.

41. The system of claim 40, wherein the program instructions for scheduling include program instructions for scheduling the warm-up process so that a completion of the warm-up process is scheduled to closely coincide with at least a portion of the print job being formatted so that it can be utilized by a print engine.

42. The system of claim 39, wherein the program instructions for estimating include program instructions for acquiring timing data corresponding to the timing factor and estimating the composition time based on the timing data.

43. The system of claim 42, wherein the timing data include a maximum composition time and an average composition time and wherein estimating the composition time based on the composition data comprises providing the maximum composition time and the average composition time.

44. A system, comprising:
a computer readable medium storing program instructions for identifying a first timing factor for a first print job, for monitoring an actual time required to compose the first print job, and for associating the actual time with the first timing factor; and
a processor capable of executing the program instructions.

45. The system of claim 44, wherein the program instructions for associating include program instructions for updating timing data corresponding to the first timing factor to reflect the actual time required to compose the first print job.

46. The system of claim 45, wherein the computer readable medium stores program instructions for:
identifying a second timing factor for a second print job; and
obtaining second timing data corresponding to the second timing factor to estimate a composition time for the second print job.

47. The system of claim 46, wherein when the second timing factor is the same as the first timing factor, the estimated composition time for the second print job will be based at least in part on the actual time required to compose the first print job.

48. An image forming device, comprising:
a print engine operable to form a desired image on a medium;
a computer readable medium storing program instructions for:
identifying a timing factor for a print job;
estimating a composition time and a format time for the print job, the composition time being based at least in part on the timing factor;
assembling the print job;
formatting the print job;
initiating a warm-up process for a print engine according to the estimated composition time and format time so the warm-up process is scheduled to complete as at least a portion of the print job is formatted and in condition to be printed; and
directing the print engine to begin producing the formatted print job once the warm-up process is complete; and
a processor operable to execute the program instructions.

49. The system of claim 48, wherein the computer readable medium stores program instructions for updating the estimated format time, and wherein the program instructions for initiating include program instructions for initiating the warm-up process for the print engine according to the updated format time.

50. The system of claim 48, further comprising a scan engine operable to scan an image, and wherein the program instructions for identifying a timing factor include program instructions for identifying a composition option for an image to be scanned, directing the scan engine to scan the image, and wherein the program instructions for assembling include program instructions for assembling the print job from the scanned image according to the composition option.

51. The system of claim 48, wherein the computer readable medium stores program instructions for monitoring an actual time required to compose the print job and for associating the actual time with the timing factor.

52. The medium of claim 51, wherein the program instructions for associating include program instructions for updating timing data corresponding to the timing factor to reflect the actual time required to compose the print job.

53. A system, comprising:
a means for identifying a timing factor for a print job; and
a means for estimating a composition time for the print job using the timing factor.

54. An image forming device, comprising:
a print engine operable to form a desired image on a medium;
a means for identifying a timing factor for a print job;
a means for estimating a composition time and a format time for the print job, the composition time being based at least in part on the timing factor;
a means for assembling the print job;
a means for formatting the print job;
a means for initiating a warm-up process for a print engine according to the estimated composition time and format time so the warm-up process is scheduled to complete as at least a portion of the print job is formatted and in condition to be printed; and
a means for directing the print engine to begin producing the formatted print job once the warm-up process is complete.
